(19) United States
(12) Patent Application Publication
(10) Pub. No.: US 2006/0108386 A1
(43) Pub. Date: May 25, 2006

(54) Woven tape and a shoulder strap incorporating such a tape

(76) Inventor: Ah Ping Lam, Jiangmen (CN)

Correspondence Address: SMITH-HILL AND BEDELL, P.C., 16100 NW CORNELL ROAD, SUITE 220, BEAVERTON, OR, 97006, US

(21) Appl. No.: 11/140,274

(22) Filed: May 26, 2005

(30) Foreign Application Priority Data
Nov. 15, 2004 (CN) 200410052193.1

(51) Int. Cl. A61G 1/00; A61G 5/00

(52) U.S. Cl. 224/158

(57) ABSTRACT

A woven tape is disclosed as including an integrally woven body, along a warp-wise direction of which being provided with alternating closed length sections closed on both lateral sides and open length sections with at least one opening on a lateral side. A shoulder strap incorporating such a woven tape is also disclosed.

This invention relates to a woven tape and a shoulder strap incorporating such a woven tape, e.g. for use in ladies' underwear.

### BACKGROUND OF THE INVENTION

Woven tapes are widely used in the textile industry and for other daily purposes, in particular in the clothing industry. Woven tapes may be elastic or inelastic, and may be suitably adjusted for variation of looseness or tightness. The length of such woven tapes is mainly adjusted by a slider/adjuster generally in the shape of the numeral “8”. Using the shoulder straps most commonly found in ladies' underwear as an example, and as shown in FIG. 1, a conventional woven tape 1 passes from above across a cross-rib of a “8” slider/adjuster 2. After passing through a slot of a ring 3, the tape 1 passes again from above across the cross-rib of the slider/adjuster 2, and is then fixed to itself by sewing. It can be seen that the formation of such a shoulder strap is cumbersome, not easily grasped by ordinary people, and complicates the production process. In case the slider/adjuster 2 is loosened, as the user is not familiar with the production process, it is not easy for the user to repair the shoulder strap.

When a clothing item, e.g. a ladies' underwear, incorporating such a conventional shoulder strap is worn, the shoulder strap is in fact kept in its place by the frictional force between the overlying inner and outer parts of the shoulder strap. When the abutting surfaces of the two layers are relatively smooth, there may be insufficient frictional force to keep the shoulder strap at a desired length. The strap may be lengthened by pulling force. Thus, in addition to not being able to assist in maintaining the figure of the user, the shoulder strap may slip over the shoulder of the wearer, embarrassing the user. Furthermore, as the engaging part between the “8” slider/adjuster and the surface of the woven tape is uneven, such may be perceivable by an onlooker, if the user wears tightly fitted clothing.

It is thus an object of the present invention to provide a woven tape in which the aforesaid shortcomings are mitigated, or at least to provide a useful alternative to the trade and public.

It is a further object of the present invention to provide a woven tape which is simple in structure, convenient to use, and comfortable to wear, and allows easy length adjustment.

It is a yet further object of the present invention to provide a shoulder strap for a clothing article incorporating such a woven tape.

### SUMMARY OF THE INVENTION

According to a first aspect of the present invention, there is provided a woven tape with an integrally woven body, characterized in that along a warp-wise direction of said body are provided at least two closed length sections closed on both lateral sides, and at least one open length section with at least one opening on a lateral side thereof, wherein said at least one open length section is disposed between said at least two closed length sections.

According to a second aspect of the present invention, there is provided shoulder strap for a clothing article, wherein said strap includes a woven tape with an integrally woven body, characterized in that along a warp-wise direction of said body are provided at least two closed length sections closed on both lateral sides, and at least one open length section with at least one opening on a lateral side thereof, wherein said at least one open length section is disposed between said at least two closed length sections.

### BRIEF DESCRIPTION OF THE DRAWINGS

Preferred embodiments of the present invention will now be described, by way of examples only, with reference to the accompanying drawings, in which:

FIG. 1 shows a conventional woven tape used as a shoulder strap;

FIG. 2 is a schematic diagram of a woven tape according to a first embodiment of the present invention;

FIG. 3 is a diagram showing a shoulder strap incorporating the woven tape shown in FIG. 2;

FIG. 4 shows the shoulder strap shown in FIG. 3 in use;

FIG. 5 is a weaving diagram of a closed length section of the woven tape shown in FIG. 2;

FIG. 6 is a weaving diagram of an open length section of the woven tape shown in FIG. 2;

FIG. 7 is a schematic diagram of a woven tape according to a second embodiment of the present invention;

FIG. 8 shows the woven tape shown in FIG. 7 fixed with a hook; and

FIG. 9 is a schematic diagram of a woven tape according to a third embodiment of the present invention.

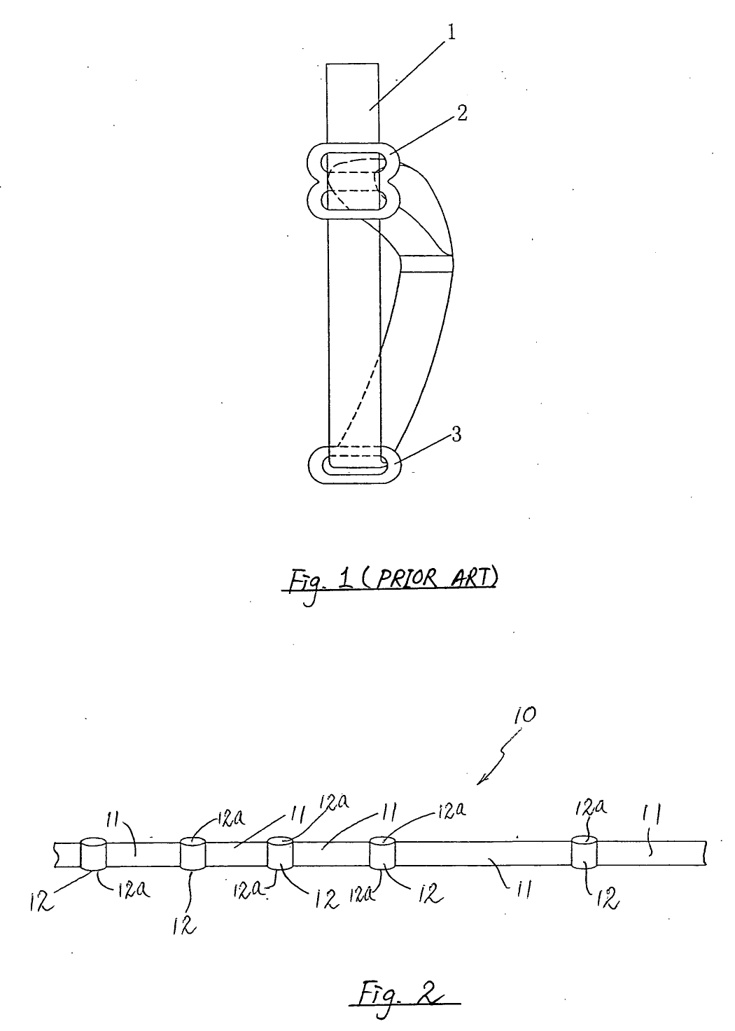

### DETAILED DESCRIPTION OF THE PREFERRED EMBODIMENTS

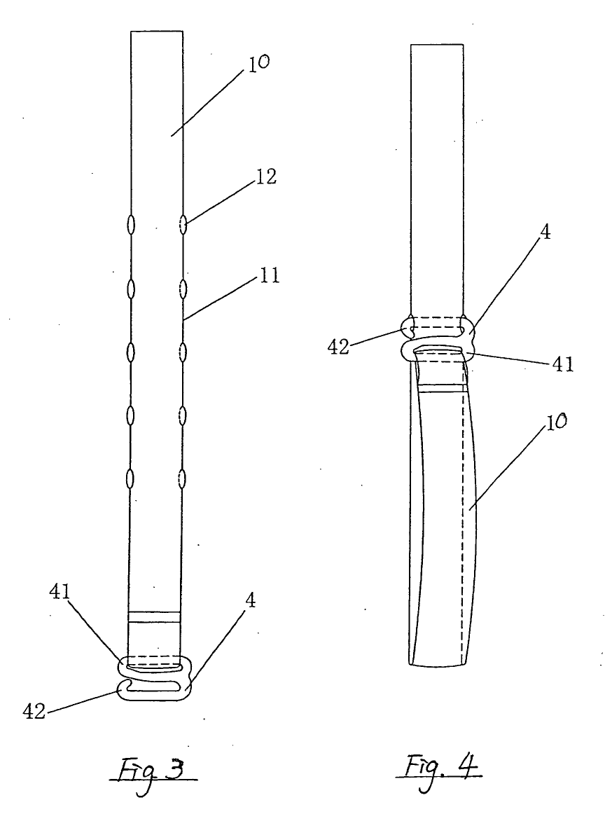

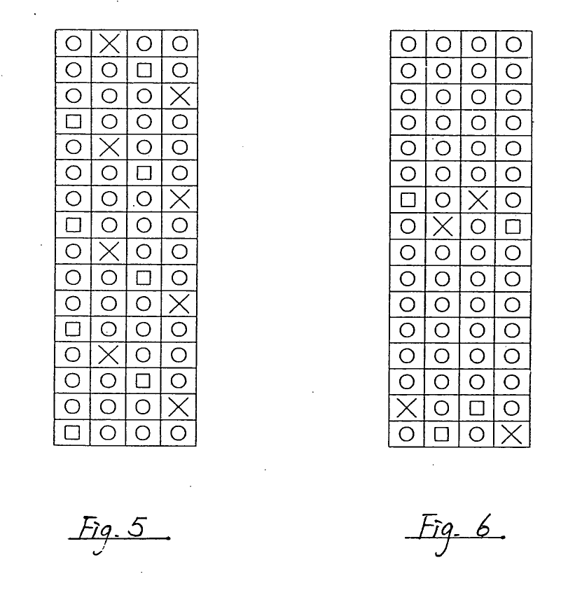

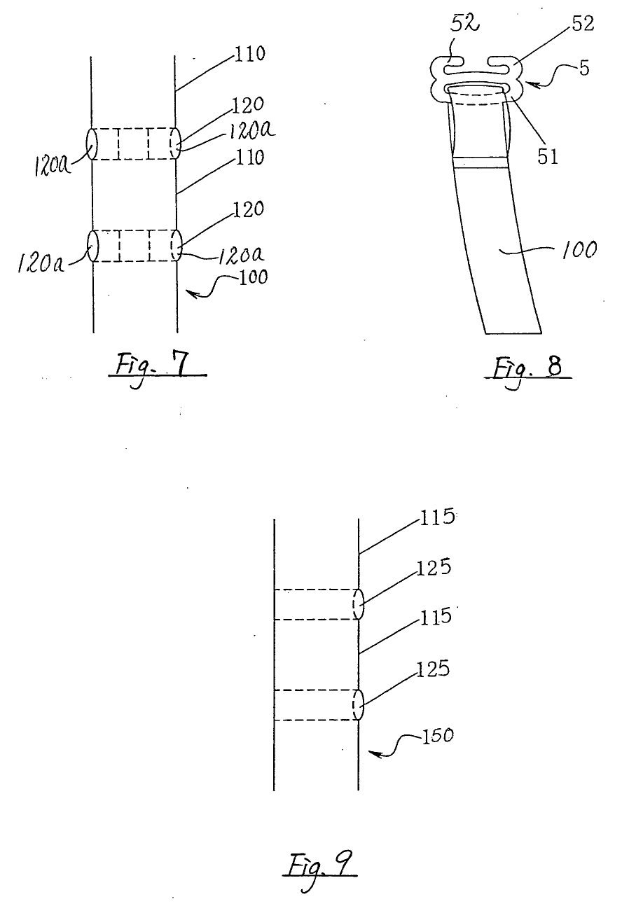

A woven tape according to a first embodiment of the present invention is shown in FIG. 2, and generally designated as 10. The tape 10 has an integrally woven double-ply main body with alternating closed length sections 11 and open length sections 12 along its warp-wise direction. It can be seen that both lateral sides of the closed length sections 11 are closed; whereas both lateral sides of the open length sections 12 are open at certain locations, with openings 12a. The openings 12a of each open length section 12 communicate with each other to form a through hole running across the open length section 12.

The tape 10 is particularly suitable for use as a shoulder strap, e.g. of a ladies' underwear, as shown in FIGS. 3 and 4. The tape 10 is fixed with a hook 4 generally in the shape of a numeral “9”, which is formed of a closed loop 41 and a hook portion 42 fixedly secured with and extending from the closed loop 41. As shown in FIG. 3, a length of the tape 10 passes through the closed loop 41 of the hook 4 and is sewn on itself to form a closed loop for securing with the closed loop 41 of the hook 4. In use, and as shown in FIG. 4, a user may insert the hook portion 42 through the openings of the open length section 12, for engaging the hook 4 with the openings of the open section 12, thus varying the effective length of the tape 10. With at least two open length sections 12, the hook 4 may be selectively releasably engaged with one of such open length sections 12 to vary the effective length of the strap.

The closed length sections 11 and open length sections 12 are all woven integrally, not necessitating sewing or other types of connecting procedure. These two kinds of length sections are of different weaving structures, of which an example of each are given here. The weaving diagram in FIG. 5 is that for weaving a closed length section 11 of the woven tape 10, in which “X” indicates that the warp thread lies on two weft threads, “◯” indicates that the warp thread passes between two weft threads, and “□” indicates that the warp thread lies under two weft threads. The weaving may be carried out by a shuttle-less weaving machine, e.g. a weaving machine from Muller, of Switzerland, under Model NFJM (HMT). The length of the closed length sections 11 and open length sections 12 may be set according to need. In addition, the elasticity, width, integrally woven patterns and ornaments, and decorations to the edges may all be varied according to need, which may result in revision of the weaving structure.

A woven tape according to a second embodiment of the present invention is shown in FIG. 7, and generally designated as 100. The tape 100 has an integrally woven main body with alternating closed length sections 110 and open length sections 120 arranged along its warp-wise direction. Each open length section 120 is open on both lateral sides, but is closed in between, so that openings 120a of each length section do not communicate with each other. Such an open length section 120 may be used in conjunction with a hanging hook 5 as shown in FIG. 8. The hook 5 includes a closed loop 51 from which extend two hook portions 52, which point towards each other. Each of the hook portions 52 may thus be received within a respective opening 120a of an open length section 120. An advantage of such an arrangement is that as the engagement between the open length section 120 and the hook 5 is symmetrical, such can withstand a higher pulling force.

A woven tape according to a third embodiment of the present invention is shown in FIG. 9, and generally designated as 150. The tape 150 has an integrally woven main body with alternating closed length sections 115 and open length sections 125 along its warp-wise direction. Each of the open length sections 125 is open on one lateral side, and closed on another lateral side. A hook (e.g. the hook 4 discussed above) is releasably engageable with such an open length section by being inserted into the opening and be retained in position by frictional engagement, e.g. by the resilient pressing of the tape 150.

It can be seen that as a woven tape made in accordance with this invention provides a number of openings for releasable engagement with the hook, the effective length of the woven tape may thus be easily, stably and reliably adjusted by the user, avoiding the embarrassment of sliding off of the traps. In addition, the openings and the closed side of the tape have the same surface, and the openings are positioned on two lateral sides of the tape, and the hook is fixed between upper and lower surfaces of the tape. The smoothness, aesthetic quality and comfort of the tape are thus maintained.

It should be understood that the above only illustrates examples whereby the present invention may be carried out, and that various modifications and/or alterations may be made thereto without departing from the spirit of the invention.

It should also be understood that certain features of the invention, which are, for clarity, described in the context of separate embodiments, may be provided in combination in a single embodiment. Conversely, various features of the invention which are, for brevity, described in the context of a single embodiment, may also be provided separately or in any appropriate sub-combinations.

What is claimed is:

1. A woven tape with an integrally woven body, characterized in that along a warp-wise direction of said body are provided at least two closed length sections closed on both lateral sides, and at least one open length section with at least one opening on a lateral side thereof, wherein said at least one open length section is disposed between said at least two closed length sections.

2. A woven tape according to claim 1 wherein said open length section has an opening on each lateral side.

3. A woven tape according to claim 2 wherein said openings communicate with each other to form a channel across said body.

4. A woven tape according to claim 1 wherein said open length section has an opening on a lateral side.

5. A woven tape according to claim 4 wherein said opening leads to a closed end.

6. A woven tape according to claim 1 wherein said closed section is an integrally woven double-ply woven tape.

7. A shoulder strap for a clothing article, wherein said strap includes a woven tape as claimed in claim 1.

8. A shoulder strap according to claim 5, further including an engaging member releasably engageable with said at least one opening.

9. A shoulder strap according to claim 6, further including a plurality of openings, each being selectively releasably engageable with said engaging member.

10. A shoulder strap according to claim 5 wherein said engaging member includes a male portion at least partly receivable within said opening.

11. A shoulder strap according to claim 8 wherein said engaging member is generally in the shape of a number “9”.

12. A shoulder strap according to 5 wherein said open length section of said body has an opening on each lateral side.

13. A shoulder strap according to claim 10 further including an engaging member with at least two male portions, each said male portion being partly receivable within each said opening.

14. A shoulder strap according to claim 11 wherein said male portions of said engaging member point generally towards each other.
